(19) United States
(12) Patent Application Publication
(10) Pub. No.: US 2020/0104403 A1
(43) Pub. Date: Apr. 2, 2020

(54) SYSTEM AND METHOD FOR VISUALLY REPRESENTING USER'S BROWSING HISTORY IN STRUCTURED MANNER

(71) Applicant: Innoplexus AG, Eschborn (DE)

(72) Inventor: Vatsal Agarwal, Rampur (IN)

(21) Appl. No.: 16/147,767

(22) Filed: Sep. 30, 2018

(51) Int. Cl. G06F 17/30

(52) U.S. Cl. CPC G06F 17/30554; G06F 17/30864

(57) ABSTRACT

Disclosed is system for visually representing user's browsing history in structured manner, system comprising: memory unit for storing user's browsing history having plurality of search queries and Uniform Resource Identifiers; ontological databank comprising plurality of concepts; data processing arrangement communicably coupled to memory unit and ontological databank, data processing arrangement comprising: retrieval module for retrieving the plurality of search queries, analyzer module for analyzing plurality of search queries for determining concept associated with the search query based on keyword present therein using ontological databank, semantic relations between search queries, based on concepts associated therewith, and generator module for generating hierarchical structure having display elements and hierarchical-relations between display elements, wherein display elements correspond to search queries and corresponding Uniform Resource Identifiers, and wherein hierarchical-relations between display elements are generated based on semantic-relations between search queries; and client device having display interface for displaying the hierarchical structure.

### TECHNICAL FIELD

The present disclosure relates generally to systems for visually representing user's browsing history in structured manner; and more specifically, to methods for visually representing user's browsing history in structured manner.

### BACKGROUND

With the increase of information available on the internet, accessing information from therein has become a primary need of every industry. Generally, web-based search engines are employed by users of the internet to find and explore content. Conventionally, upon providing search terms, the search engine finds relevant web pages and displays the web pages as search results to the user. Typically, the search engine displays the relevant web pages with a list of links to web pages and text-based excerpts of the content at the linked web page.

However, the conventional operation of the web-based search engines has several problems. For instance, searching for a specific topic or item via a search engine involves using a plurality of search queries in trial and error process. The search query generating appropriate results in such process is usually formed of various concepts, terms and/or contents recognized in the results generated while using the plurality of search queries. However, such technique of creating the search query is exceedingly time consuming and cumbersome. Moreover, the conventional web-based search engine maintains a record of websites with metadata such as time, place and device. However, the record is merely a list of the websites visited by a user from a device at specific time and place. However, the record fails to describe various aspects of the search such as, relation between the various search queries, specific results related to a search query, specific search quires that were useful for the user and the like. Furthermore, in the research industry that searches a single topic or item for days, weeks or even months, having merely a list of websites in a record can be inefficient.

Therefore, in light of the foregoing discussion, there exists a need to overcome the aforementioned drawbacks associated with the conventional operation of the web-based search engine.

### SUMMARY

The present disclosure seeks to provide a system for visually representing a user's browsing history in a structured manner. The present disclosure also seeks to provide a method for visually representing a user's browsing history in a structured manner. The present disclosure seeks to provide a solution to the existing problem of recording merely a list of websites visited by a user with metadata such as time, place and device. An aim of the present disclosure is to provide a solution that overcomes at least partially the problems encountered in prior art, and provides an efficient way of keeping track of time line and other details associated with search process and thereby reduces time and effort required for backtracking and analyzing the search process.

In one aspect, an embodiment of the present disclosure provides a system for visually representing a user's browsing history in a structured manner, the system comprising:
a memory unit for storing the user's browsing history having a plurality of search queries and Uniform Resource Identifiers corresponding to the plurality of search queries;
an ontological databank comprising a plurality of concepts;
a data processing arrangement communicably coupled to the memory unit and the ontological databank, the data processing arrangement comprising:
   a retrieval module for retrieving the plurality of search queries,
   an analyzer module for analyzing each of the plurality of search queries for determining,
      at least one concept associated with each of the search query based on at least one keyword present therein using the ontological databank,
      semantic relations between the plurality of search queries, based on the concepts associated therewith, and
   a generator module for generating a hierarchical structure having a plurality of display elements and a plurality of hierarchical-relations between the plurality of display elements, wherein the plurality of display elements correspond to the plurality of search queries and corresponding Uniform Resource Identifiers, and wherein the plurality of hierarchical-relations between the plurality of display elements are generated based on semantic-relations between the plurality of search queries; and
a client device having a display interface for displaying the hierarchical structure.

In another aspect, an embodiment of the present disclosure provides a method for visually representing a user's browsing history in a structured manner, wherein the method is implemented using a system comprising:
a memory unit for storing the user's browsing history having a plurality of search queries and Uniform Resource Identifiers corresponding to the plurality of search queries;
an ontological databank comprising a plurality of concepts;
a data processing arrangement communicably coupled to the memory unit and the ontological databank, wherein the method comprises:
   retrieving the plurality of search queries,
   analyzing each of the plurality of search queries for determining
   at least one concept associated with each of the search query based on at least one keyword present therein using the ontological databank,
   semantic relations between the plurality of search queries, based on the concepts associated therewith, and
   generating a hierarchical structure having a plurality of display elements and a plurality of hierarchical-relations between the plurality of display elements, wherein the plurality of display elements corresponds to the plurality of search queries and corresponding Uniform Resource Identifiers, and wherein the plurality of hierarchical-relations between the plurality of display elements are generated based on semantic-relations between the plurality of search queries, and
   displaying the hierarchical structure on a display interface of a client device, wherein the client device is communicably coupled to the data processing arrangement.

Embodiments of the present disclosure substantially eliminate or at least partially address the aforementioned problems in the prior art, and enable access transaction of the document in a secure environment.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of an architecture of a system for visually representing a user's browsing history in a structured manner, in accordance with an embodiment of the present disclosure;

FIG. 2 is a schematic illustration of an exemplary view of a display interface for displaying a hierarchical structure to be displayed on client device, in accordance with an embodiment of the present disclosure;

FIGS. 3 is a schematic illustration of another exemplary view of a display interface for displaying a hierarchical structure to be displayed on client device, in accordance with another embodiment of the present disclosure;

FIGS. 4 is a schematic illustration of an exemplary view of a display interface for displaying graphical structures to be displayed on client device, in accordance with an embodiment of the present disclosure; and

FIGS. 5 is an illustration of steps of a method for (of) visually representing a user's browsing history in a structured manner, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented.

Although some modes of carrying out the present disclosure have been disclosed, those skilled in the art would recognize that other embodiments for carrying out or practicing the present disclosure are also possible.

In one aspect, an embodiment of the present disclosure provides a system for visually representing a user's browsing history in a structured manner, the system comprising:
a memory unit for storing the user's browsing history having a plurality of search queries and Uniform Resource Identifiers corresponding to the plurality of search queries;
an ontological databank comprising a plurality of concepts;
a data processing arrangement communicably coupled to the memory unit and the ontological databank, the data processing arrangement comprising:
   a retrieval module for retrieving the plurality of search queries,
   an analyzer module for analyzing each of the plurality of search queries for determining
      at least one concept associated with each of the search query based on at least one keyword present therein using the ontological databank,
      semantic relations between the plurality of search queries, based on the concepts associated therewith, and
   a generator module for generating a hierarchical structure having a plurality of display elements and a plurality of hierarchical-relations between the plurality of display elements, wherein the plurality of display elements correspond to the plurality of search queries and corresponding Uniform Resource Identifiers, and wherein the plurality of hierarchical-relations between the plurality of display elements are generated based on semantic-relations between the plurality of search queries; and
a client device having a display interface for displaying the hierarchical structure.

In another aspect, an embodiment of the present disclosure provides a method for visually representing a user's browsing history in a structured manner, wherein the method is implemented using a system comprising:
a memory unit for storing the user's browsing history having a plurality of search queries and Uniform Resource Identifiers corresponding to the plurality of search queries;
an ontological databank comprising a plurality of concepts;
a data processing arrangement communicably coupled to the memory unit and the ontological databank, wherein the method comprises:
   retrieving the plurality of search queries,
   analyzing each of the plurality of search queries for determining
   at least one concept associated with each of the search query based on at least one keyword present therein using the ontological databank,
   semantic relations between the plurality of search queries, based on the concepts associated therewith, and
   generating a hierarchical structure having a plurality of display elements and a plurality of hierarchical-relations between the plurality of display elements, wherein the plurality of display elements corresponds to the plurality of search queries and corresponding Uniform Resource Identifiers, and wherein the plurality of hierarchical-relations between the plurality of display elements are generated based on semantic-relations between the plurality of search queries, and
   displaying the hierarchical structure on a display interface of a client device, wherein the client device is communicably coupled to the data processing arrangement.

The present disclosure provides the aforementioned system and method of visually representing a user's browsing history in a structured manner. The system described herein acquires a plurality of search queries and corresponding Universal Resource Identifiers and establishes hierarchical-relations as well as context based semantic-relations therebetween. The system provides an efficient way of keeping track of time line and other details associated with a search process. Furthermore, the system allows for identifying direct as well as indirect associations among the plurality of search results and corresponding Universal Resource Identifiers. Such indirect associations among the plurality of search results and corresponding Universal Resource Identifiers may get ignored otherwise. Moreover, the invention disclosed herein reduces time and effort required for backtracking and analyzing the search process. Thereby, optimizing the search process by substantially eliminating a need of repeating the search process when required later. In addition, the system allows the user to restart, resume or analyze the search process from a desired point in the search process, whenever required. In addition, the system allows for the user to keep track of a thought process and search plan involved in the search process. Furthermore, method disclosed herein is effective, modular and platform independent. Notably, the method is implementable using existing hardware resources.

The system for visually representing a user's browsing history in a structured manner refers to a collection of one or more programmable and non-programmable components interconnected therein. Furthermore, the interconnected components are configured to acquire, and process data included in the user's browsing history (described in greater detail later). Subsequently, the data of the user's browsing history is organized based on one or more specifications, and a visual representation is generated thereafter. Furthermore, user's browsing history is conditioned for structuring the user's browsing history into a form wherein the data included therein is interrelated. It will be appreciated that user's browsing history is conditioned based on one or more parameters and relations. Subsequently, the structured user's browsing history is expressed diagrammatically for visually representing the user's browsing history.

The system comprises a memory unit for storing the user's browsing history having a plurality of search queries and Uniform Resource Identifiers corresponding to the plurality of search queries. Throughout the present disclosure, the term “memory unit” relates to a volatile or persistent medium, such as an electrical circuit, magnetic disk, virtual memory or optical disk, in which the data describing user's browsing history is stored. Optionally, the memory is non-volatile mass storage such as physical storage media. Optionally, the memory unit can be a local storage unit associated with an electronic device that is used by the user for web-browsing. For example, the memory unit can be a storage unit of a personal computer that may be configured to record activity performed by the user using a trusted browsing application hosted therein. Optionally, the memory can be stored in a remote location. For example, a trusted browsing application may be configured to store data related to the use of the browsing application in a server located at a remote location with respect to a computing device hosting the browsing application. In such example, user performing web browsing using such trusted browsing application registers itself prior to web browsing for generating a profile to be stored in the server. Subsequently, the user may use the profile for accessing the features of the trusted browsing application that enables browsing contents locally and web browsing. In such example, the trusted browsing application is configured to store data related to the web browsing of the user in relation to the profile of the user stored in the server.

The memory unit stores the user's browsing history having a plurality of search queries. Throughout the present disclosure, the term “browsing history” relates to a collection of data describing actions performed using trusted browsing application hosted in a computing device, namely the client device (described in greater detail later). The collection of data of the browsing history can include web pages accessed, a frequency and a recency of accessing the web pages, a uniform resource locator (URL), a title, and a browsing date and time at which they were accessed, method by which they were accessed, and the like. Additionally, the browsing history can include a character string, or an object used to search using the trusted browsing application. Furthermore, the browsing history can be gathered by the trusted browsing application (e.g., the web browser toolbars offered by Yahoo!®, Google®, Microsoft®, and the like). Moreover, the browsing history also include demographic information describing a user. For example, the browsing history can store the information related to identity of a user, such as a profile of a user. Therefore, “user's browsing history” refers to a history or record of the browsing activity performed by a user. Furthermore, the browsing activity performed by the user refers to the accessing of the digital content using the trusted browsing application. Additionally, the trusted browsing application enables accessing of the digital content that is stored in the computing entity hosting the trusted browsing application and accessing content available in the world wide web. Therefore, the user's browsing history can include reference (in the form of hyperlinks and/or Uniform Resource Identifiers) to content locally available and the content available on the world wide web. It will be appreciated that, the term ‘user’ as used herein relates to any entity including a person (i.e., human being), and/or a virtual personal assistant (an autonomous program or a bot) using a user device to perform the web-browsing activity.

Furthermore, the user's browsing history include a plurality of search queries. Throughout the present disclosure, the term “search query” relates to one or more term or keywords that can be used for the trusted browsing application for retrieving one or more links to digital files associated to the trusted browsing application. Examples of the search query include search queries in form of a string composed of one or more words, like “lung cancer”, or a term like “lung cancer.doc.”. It should be understood that these examples are non-limiting and should not be construed as limiting the present invention.

Furthermore, the trusted browsing application includes a user interface, namely a search interface including an input field, namely a search box wherein the user can input search term(s) for retrieving one or more links to digital files. The trusted browsing application is configured to store completely or partially the search query(s) including search term(s) entered in the search box of the search interface. Subsequently, the search queries used by the user is included in the user's browsing history. Additionally, each search query of the plurality of search queries refers to one or more domains. It will be appreciated that, a domain is a subject matter category of a specific field such as computers, bio-technology, life science, medical science, pharmaceuticals, shopping, sports, entertainment, music, or politics and the like.

Furthermore, each of the plurality of search queries is operable to fetch at least one Uniform Resource Identifier. Throughout the present disclosure, the term “Uniform Resource Identifiers” relates to any electronic object that identifies a resource on a network or a data repository and includes information for locating the resource. Optionally, the Uniform Resource Identifier acts as references to contents stored on a data repository that is accessed via a network such as the Internet.

Optionally, the Uniform Resource Identifier can include a uniform resource name and a Uniform Resource Locators. Furthermore, the Uniform Resource Identifier can be implemented as a Uniform Resource Locator. Optionally, the Uniform Resource Identifier may be provided as a hyperlink. The term “hyperlink” relates to a reference that points to a resource available via a communication network and, when selected it automatically navigates to the resource. In this regard, the hyperlink can include hypertext.

Furthermore, the user's browsing history is configured to store the Uniform Resource Identifier fetched by each of the plurality of search queries. Optionally, the system includes one or more modules to store the search queries fetching the Uniform Resource Identifiers. Furthermore, the modules are configured to structurally store the plurality of search queries and Uniform Resource Identifiers in a manner that each Uniform Resource Identifier corresponds to a search query.

The system comprises an ontological databank comprising a plurality of concepts. Throughout the present disclosure, the term “concept” relates to a term that corresponds to a topic related to a technical field (namely, a subject area, a technical domain and so forth). For example, a drug or a disease can be two concepts in a technical field, namely drug discovery. Throughout the present disclosure, the term “ontological databank” refers to a data repository that is configured to store information about a plurality of concepts, wherein said information is indicative of types of concepts, properties of the concepts and semantic inter-relationships between the concepts. It will be appreciated, a semantic inter-relationship between two given entities is indicative of a causal relationship that relates the two given entities to each other. As an example, in drug discovery, examples of a causal relationship between a drug and a disease could be “causes”, “inhibits”, “catalyses” and so on. Optionally, the ontological databank is configured to store the information about the set of concepts in a structured manner in a non-storage unit, such as memory of the data repository. Additionally, optionally, the ontological databank is configured to store information on how a certain concept in a certain technical field may be associated with one or more concepts in other field(s). In an embodiment, the ontological databank is stored at the first client device. In another embodiment, the ontological databank is stored at a database arrangement associated with the server arrangement. Optionally, the database arrangement comprises one or more databases.

The system comprises a data processing arrangement communicably coupled to the memory unit and the ontological databank. Throughout the present disclosure, the term “data processing arrangement” relates to at least one programmable or computational entity that is configured to acquire process and/or respond to one or more instructions for performing one or more tasks of the aforementioned system. In another example, data processing arrangement includes, but are not limited to, a microprocessor, a microcontroller, a complex instruction set computing (CISC) microprocessor, a reduced instruction set (RISC) microprocessor, a very long instruction word (VLIW) microprocessor, or any other type of processing circuit for executing the instructions. Furthermore, the data processing arrangement includes one or more individual processors, processing devices and various elements of a computer system associated with a processing device that may be shared by other processing devices. Additionally, one or more individual processors, processing devices, and elements are arranged in various architectures for responding to and processing the instructions that drive the system for retrieving information, for example, user's browsing history.

The data processing arrangement communicably coupled to the memory unit and the ontological databank via a communication interface. The communication interface is configured to facilitate data communication between the data processing arrangement, the memory unit and the ontological databank. Furthermore, the communication interface facilitates data communication via a collection of interconnected (public and/or private) networks that are linked together by a set of standard protocols. Examples of standard protocols may include, but not limited to, Internet® Protocol (IP), Wireless Access Protocol (WAP), Frame Relay, Asynchronous Transfer Mode (ATM), Hypertext Transfer Protocol (HTTP), File Transfer Protocol (FTP), and the likes.

The data processing arrangement comprises a retrieval module for retrieving the plurality of search queries. Throughout the present disclosure, the term “retrieval module” relates to a module comprising programmable components that is stored and executed on the data processing arrangement. Optionally, the retrieval module is implemented by way of a trusted software application that, when executed at the data processing arrangement, obtains the plurality of search queries of the user's browsing history and metainformation pertaining to the plurality of search queries. The obtaining the plurality of search queries of the user's browsing history further includes acquiring the Uniform Resource Identifiers corresponding to each of the search queries of the plurality of search queries and the and metainformation of the Uniform Resource Identifiers therein. Optionally, in such a case, the trusted software application is received (for example, downloaded) from a trusted third party. The trusted third party can be a publicly-accessible digital distribution platform, for example, such as Google Play®, the App Store® (for iOS®) and the like.

The data processing arrangement comprises an analyser module for analysing each of the plurality of search queries. Throughout the present disclosure, the term “analyser module” relates to a module comprising programmable components that are configured to store and execute set of instructions that is stored and executed on the data processing arrangement. Optionally, the analyser module is implemented by way of a trusted software application that, when executed at the data processing arrangement, is configured to analyse the plurality of search queries and metainformation pertaining to the plurality of search queries.

The analyser module analyses each of the plurality of search queries for determining at least one concept associated with each of the search query based on at least one keyword present therein using the ontological databank. Furthermore, the set of instructions stored and executed by the analyser module is configured to analyse the at least one keyword each word used to form each of the search query. Optionally, the set of instructions can include one or more algorithms for analysing the at least one keyword present in each of the search query. In an example, an algorithm for analysing the at least one keyword using the ontological databank can be n-gram technique. Furthermore, the n-gram technique may be used for the comparison of at least one keyword of a given search query with the plurality of concepts included in the ontology. It will be appreciated that the n-gram technique relates to a contiguous sequence of ‘n’ items from a given set of words (such as a search query), wherein ‘n’ represents number of words (keywords) within each of the search query. In this regard, the search query having one keyword is referred as unigram or one-gram, the search query having two keywords are referred as bigram or two-gram, the search query having three keywords are referred as trigram or three-gram. Similarly, based on the number of the keywords, the plurality of words is referred as “four-gram”, “five-gram”, and so on. In an example, the plurality of keywords generated may be “top drugs for cancer”, “top drugs for”, “drugs for cancer”, “top drugs”, “drugs for”, “for cancer”, “top”, “drugs”, “for” and “cancer”. In such an example, the plurality of keywords “top drugs for cancer” is the four-gram. Similarly, the plurality of keywords “top drugs for”, and “drugs for cancer” could be the trigram or three-gram, the plurality of words “top drugs”, “drugs for”, and “for cancer” could be bigram or two-gram and the plurality of words “top”, “drugs”, “for” and “cancer” could unigram or one-gram.

The analyser module analyses each of the plurality of search queries for determining semantic-relations between the plurality of search queries, based on the concepts associated therewith. Throughout the present disclosure, the term “semantic-relation” relates to a relationship or association between two or more search queries of the plurality of search queries. It will be appreciated that, the associations between two or more search queries includes attributes and a type or definition that provides a conceptual meaning to how the two or more between two or more search queries are related to each other. Furthermore, the semantic-relation between the plurality of search queries is determined by one or more computing algorithms that is stored and executed by the analyser module. Optionally, the analyser module determines the concept associated with any two or more search queries for determining semantic-relations. For example, a first search query may be formed of a keyword “X”, and a second search query may be formed of a keyword “Y”, in such instance the one or more computing algorithms of the analyser module determines the concept associated with X and Y. Furthermore, in such instance, the one or more computing algorithms compares the attributes of X and Y and the definition of X and Y included in the concept to determine a relation therein. Thereafter, the one or more computing algorithms co-relates the first search query and the second search query and determined the semantic-relation

Optionally, the analyser module can determine the semantic-relations between the plurality of search queries by acquiring the concepts associated with the keywords of each of the search queries for the ontological databank.

Optionally, the data processing arrangement is further configured to determine an importance score of the plurality of search queries based on a set of predefined parameters. The data processing arrangement can store and execute the programming codes or routines that can be configured to determine an importance score. Furthermore, the importance score is determined for each of the search query of the plurality of search queries based on the set of predefined parameters. Additionally, the importance score for any given search query can be any numerical value. Furthermore, the numerical value may be determined based on the set of predefined parameters.

Optionally, the set of predefined parameters for a given search query from the plurality of search queries comprises number of Uniform Resource Identifiers corresponding to the given search query. The number of Uniform Resource Identifiers corresponding to the given search query refers to the Uniform Resource Identifiers that are provided by the browsing application upon providing a given search query. For example, upon using a search query, namely “U” as an input for a browsing application 1000 Uniform Resource Identifiers are provided as output by the browsing application.

Optionally, the set of predefined parameters for a given search query from the plurality of search queries comprises number of Uniform Resource Identifiers corresponding to the given search query accessed by the user. The number of Uniform Resource Identifiers corresponding to the given search query accessed by the user refers to the Uniform Resource Identifiers that are selected by the user for further activities, such as accessing the content associated with the selected Uniform Resource Identifier. For example, the search query, namely “U” generates 1000 Uniform Resource Identifiers. In such example, the user may select 10 Uniform Resource Identifiers for accessing.

Optionally, the set of predefined parameters for a given search query from the plurality of search queries comprises metadata associated with each of the Uniform Resource Identifiers corresponding to the given search query. The metadata associated with each of the Uniform Resource Identifiers refers to the information that describes the Uniform Resource Identifiers and the one or more operations performed by the user (such as user activity), when provide by the browsing application. For example, the information may include name of a given Uniform Resource Identifier, a location of a Uniform Resource Identifier in the list when provide by the browsing application and the like.

Optionally, the metadata associated with a given Uniform Resource Identifier comprises access time associated with the given Uniform Resource Identifier. For example, a given Uniform Resource Identifier, namely “T” may be accessed by a user at 1300 hours of the 5 Dec. 2017. Optionally, the metadata associated with a given Uniform Resource Identifier comprises type of the given Uniform Resource Identifier. According to the aforementioned, the Uniform Resource Identifier “T” may be a uniform resource locator that directs to a website. Optionally, the metadata associated with a given Uniform Resource Identifier comprises user activity associated with the given Uniform Resource Identifier. Furthermore, the user activity refers to the operations performed the user using one or more tools or features of the browsing application providing the Uniform Resource Identifiers corresponding to the given search query. Optionally, the user activity associated with a given Uniform Resource Identifier comprises recording of web-addresses with the given Uniform Resource Identifier. In an example, recording of web-addresses with the given Uniform Resource Identifier may be storing the web-addresses associated with a given Uniform Resource Identifier in an associated data repository of the browsing application providing the Uniform Resource Identifier. Optionally, the user activity associated with a given Uniform Resource Identifier comprises number of accesses associated with the given Uniform Resource Identifier. In an example, the number of accesses may be the number of times the user selected a given Uniform Resource Identifier for viewing its content.

In an example, number of Uniform Resource Identifiers corresponding to the given search query “T” may be 2000, number of Uniform Resource Identifiers corresponding to the given search query “T” accessed by the user may be 20, the access time associated with a given Uniform Resource Identifier may be 1300 hours of the 5 Dec. 2017, the given Uniform Resource Identifier may be a uniform resource locator, and user activity associated with the given Uniform Resource Identifier may include storing the web-addresses associated to the given Uniform Resource Identifier, and number of accesses associated with the given Uniform Resource Identifier may be 3. Furthermore, in an example, number of Uniform Resource Identifiers corresponding to the another given search query “W” may be 5000, number of Uniform Resource Identifiers corresponding to the given search query “W” accessed by the user may be 5, the access time associated with a given Uniform Resource Identifier may be 1200 hours of the 5 Dec. 2017, and the given Uniform Resource Identifier may be a uniform resource locator. In such example, the programming codes or routines that can be configured to determine an importance score may assign an importance score that is greater value to the search query “T” as compared to the search query “W”.

Furthermore, the system comprises the generator module for generating the hierarchical structure having the plurality of display elements and the plurality of hierarchical-relations between the plurality of display elements. The generator module is a hardware-based and/or software-based component within the system, wherein the generator module is configured to generate a graphical structure for representing the plurality of search queries and corresponding search results and relationships between the plurality of search queries and corresponding search results. The search results are Uniform Resource Identifiers for webpages having content relevant to the plurality of search queries. Notably, the graphical structure generated by the generator module is the hierarchical structure, wherein the hierarchical structure is a non-linear structure relating to the search queries and search results associated with the search queries. The hierarchical structure includes a plurality of nodes therein. The plurality of nodes within the hierarchical structure include: a root node, leaf nodes and body nodes. In an example, the plurality of nodes may be represented as a circular shape, a rectangular shape, a three-dimensional shape and the like. Furthermore, the root node of the hierarchical structure is a first node (namely, a base node) that is accessed while retrieving data from the hierarchical structure. In addition, the root node has one or more nodes associated thereto, wherein nodes associated with the root node are body nodes and/or leaf nodes. Additionally, a node that does not have a child node associated therewith is a leaf node. Furthermore, nodes between the leaf nodes and the root node of the hierarchical structure are body nodes. Notably, a first node is parent node of a second node associated thereto, wherein the first node appears above the second node in the hierarchical structure. Therefore, the second node is a child node to the first node. Moreover, the second node has a third node associated thereto, wherein the third node appears below the second node, in such a scenario the second node is a parent node to the third node and the third node is a child node to the second node. Furthermore, the hierarchical structure has a height (namely, depth) associated therewith. Notably, the height of the hierarchical structure depends upon number of parent node and child node associations (namely, hierarchical-relations) present within the hierarchical structure.

It will be appreciated that the plurality of nodes within the hierarchical structure are referred herein as the plurality of display elements. Furthermore, associations between the plurality of nodes within the hierarchical structure are referred herein as the hierarchical-relations between the plurality of display elements.

Moreover, the plurality of display elements corresponds to the plurality of search queries and corresponding Uniform Resource Identifiers. Notably, each of the plurality of display elements within the hierarchical data structure represent at least one of the plurality of search queries or at least one corresponding Uniform Resource Identifiers. Beneficially, representing the plurality of search queries and corresponding Uniform Resource Identifiers with the plurality of display elements allows for an easier identification and retrieval of the plurality of search queries and corresponding Uniform Resource Identifiers by the user. In addition, the Uniform Resource Identifiers are plurality of search results corresponding to the plurality of search queries.

Optionally, the plurality of display elements corresponding to the plurality of search queries and the plurality of display elements corresponding Uniform Resource Identifiers are visually identical. Alternatively, the plurality of display elements corresponding to the plurality of search queries and the plurality of display elements corresponding Uniform Resource Identifiers are different in at least one of: shape, size, texture and the like.

Furthermore, the plurality of hierarchical-relations between the plurality of display elements are generated based on semantic-relations between the plurality of search queries. The semantic-relations between the plurality of display elements are identified based on concepts associated therewith. Notably, each of the plurality of display elements has at least one concept associated therewith based on context of corresponding the plurality of search queries and corresponding Uniform Resource Identifiers. Therefore, two or more of the plurality of display elements having common concept associated therewith have semantic-relation therebetween. In an example, a first display element corresponding to a first search query “blood cancer” may have a concept “cancer” associated therewith. A second display element corresponding to a second search query “Ductal Carcinoma in situ” having the concept “cancer”. Consequently, association of the concept “cancer” with both the first and second display elements exhibit a semantic-relation therebetween. Notably, the semantic-relations between the plurality of display elements allows for the hierarchical-relations within the hierarchical structure.

Optionally, the sematic-relations between the plurality of display elements are identified by identifying common keywords. In an example, the plurality of display elements having search queries “Lung Cancer” and “Breast Cancer” have common keyword “Cancer” that allows for identification of a semantic-relation therebetween.

Furthermore, the semantic-relations between the plurality of display elements are identified based on identified semantic-relations within the ontological databank. In an example, the ontological databank includes a given semantic-relation “cures” between a drug “Deuretics” and condition “Hypertension”. Furthermore, the given semantic-relation in the ontological databank may be used to identify semantic-relation between the plurality of display elements corresponding to search queries “Hypertension” and “Deuretics”.

Optionally, the plurality of display elements corresponding to the plurality of search queries have sematic-relations with one or more of the plurality of display elements corresponding to Uniform Resource Identifiers. In an example, a search query “chocolate cake” having a concept “bakery” may have a sematic-relation with a Uniform Resource Identifier associated with homepage of a confectionery and bakery “Mr. Brown” having a concept “bakery and chocolates”.

Optionally, in an instance, the plurality of display elements having sematic-relations have distinct concepts associated therewith in addition to a common concept therebetween. In an example, the plurality of display elements corresponding to search queries “Chocolate cake” and “Juice” have a common concept “sweet” associated therewith. In addition, the search query “Chocolate cake” has another concept “Bakery” associated therewith and the search query “Juice” has a concept “Fruit” associated therewith.

More optionally, the plurality of display elements corresponding to Uniform Resource Identifiers have semantic-relations with two or more of the plurality of display elements corresponding to the plurality of search queries. In an example, a Uniform Resource Identifier associated with homepage of official website for “a company making electronic appliances” may have semantic-relations with a first search query “Electric Grill” having a concept “home appliances” and a second search query “Oven” having a concept “Baking”.

Optionally, the plurality of display elements corresponding to Uniform Resource Identifiers have semantic-relations therebetween. In an example, the Uniform Resource Identifier of a webpage of a Baking company including varieties of chocolates manufactured by the company have a sematic-relation with webpage of the baking company including varieties of cakes manufactured by the company.

Optionally, the plurality of display elements corresponding to the plurality of search queries have sematic-relations therebetween. In an example, a first search query may be “hockey” and have a concept “sport” associated therewith. Furthermore, a second search query may be “cricket” and have the concept “sport” associated therewith. Therefore, association of the concept “sport” with the first and the second search queries exhibit a semantic-relation therebetween.

Optionally, the plurality of display elements is grouped together based on sematic-relations therebetween. The plurality of display elements that do not have semantic-relations therebetween are separated by grouping them in different portions of the hierarchical structure.

Optionally, the plurality of display elements corresponding to the plurality of search queries are represented in multiple sizes in the hierarchical structure, and wherein a size of a given display element is determined based on the importance score of the search query corresponding to the given display element. As mentioned previously, the plurality of display elements corresponding to the plurality of search queries and the Uniform Resource Identifiers are represented as the plurality of nodes in the hierarchical structure. Furthermore, a size of the plurality of nodes representing the plurality of display elements in the hierarchical structure signify usefulness and relevance of the search queries and the Uniform Resource Identifiers corresponding to the plurality of display elements. In an instance, the plurality of display elements is represented as circular structures. Furthermore, a first display element from the plurality of display elements may have an importance score greater than an importance score of a second display element from the plurality of display elements. In such an instance, the first display element may be represented with a larger circular structure and the second display element may be represented with a smaller circular structure. In an example, a user provides a search query “Lipstick”, wherein the search query “Lipstick” may have sematic-relations with Uniform Resource Identifiers of webpages of Lipstick manufacturing companies such as “Maybellin”, “Laknne”, “MAC” and the like. Notably, the user spends maximum time on webpages linked with Uniform Resource Identifiers of official website of Lipstick manufacturing company “MAC” and bookmarks one of the webpages associated with the official website. Therefore, an importance score of the Uniform Resource Identifiers of Lipstick manufacturing company “MAC” is higher than importance scores of the Uniform Resource Identifiers of Lipstick manufacturing companies “Maybellin” and “Laknne”. Consequently, size of the circular structures representing the plurality of display elements corresponding to Uniform Resource Identifiers of Lipstick manufacturing company “MAC” is larger in size as compared to size of circular structures representing the plurality of display elements corresponding to Uniform Resource Identifiers of Lipstick manufacturing companies “Maybellin” and “Laknne”.

Optionally, the plurality of display elements having semantic-relations therebetween are color-coded with similar colours to represent conceptual similarity therebetween. In addition, the plurality of display elements having distinct semantic-relations are color-coded with distinct colours to represent a conceptual difference between the plurality of display elements.

Furthermore optionally, the hierarchical-relations between the plurality of display elements are color-coded to represent similar semantic associations. In an example, hierarchical-relations between drugs and one or more conditions treated by the drugs are color-coded with similar colours to represent a similarity between semantic-relations between plurality of display elements corresponding to drugs and plurality of display elements corresponding to conditions treated by the drugs.

In an example, a hierarchical structure contains a plurality of display elements corresponding to one search query and two Uniform Resource Locators corresponding to the search query, wherein the search query may be root node of the hierarchical structure and parent node to the two Uniform Resource Locators corresponding to the search query. Therefore, the two Uniform Resource Locators corresponding to the search query are child node to the root node comprising the search query. The search query may be “Diabetes” and the two Uniform Resource Locators corresponding to the search query may be links to a webpage comprising symptoms of “Diabetes” and another webpage comprising drugs for treating “Diabetes”. The link (namely, edge) between the search query and the two Uniform Resource Locators corresponding to the search query may be a hierarchical-relation therebetween.

In an example, the plurality of display elements represents the user query by redirecting to a memory location where the user query is stored. In yet another example, the plurality of display elements may be shown as a geometrical shape (regular or irregular) and the user query may be written within the plurality of display elements.

Optionally, each of the plurality of display elements corresponding to the plurality of search queries comprise an associated summary therewith. The summary associated with each of the plurality of display elements comprise data associated with the plurality of search queries and corresponding Uniform Resource Identifiers. The summary associated with the plurality of display elements corresponding to the plurality of search queries includes: number of corresponding search results, time of search, date of search, time spent on analysing results, number of downloads bookmarks saved using a given search query, number of downloads using the given search query, keywords of the given search query, number of times the given search query has been used, databases and/or webpages analysed by a search engine for generating the search results and so forth. Furthermore, the summary associated with the Uniform Resource Identifiers include: associated date and time, keywords matched with corresponding search query, keywords not matched with corresponding search query, time spent on analysing a given Uniform Resource Identifier, number of times the given Uniform Resource Identifier has been analysed, number of bookmarks and downloads using the given Uniform Resource Identifier and so forth.

In an embodiment, the summaries associated with the plurality of display elements is represented using an annotation. The summaries are linked to the plurality of display elements by way of annotations in form of text, keywords, images and the like. Alternatively, the annotations comprise links to memory locations comprising the summaries associated with the plurality of display elements. Furthermore, the summaries associated with the plurality of display elements may be linked by way of one or more labels associated with the plurality of display elements.

Furthermore, the system further comprises the client device having the display interface for displaying the hierarchical structure. The client device is configured to receive the plurality of search queries and display the hierarchical structure that visually represents the user's browsing history in a structured manner. The hierarchical structure represented by the client device includes the plurality of search queries and corresponding Uniform Resource Identifiers represented by way of the plurality of display elements. Furthermore, the term “client device” generally refers to a device executing an application, program, or process that acquires information or services from a user, another application, program, process, or device (for example, a server) on a data communication network. The client device is a combination of software and hardware components. The client device allows the user (such as an individual and/or organization) to enter the search query. In an example, the client device can be implemented using but not limited to, mobile phones, smart telephones, Mobile Internet Devices (MIDs), tablet computers, Ultra-Mobile Personal Computers (UMPCs), phablet computers, Personal Digital Assistants (PDAs), web pads, Personal Computers (PCs), handheld PCs, laptop computers, desktop computers, large-sized touch screens with embedded PCs, a server, and Network-Attached Storage (NAS) devices. The user enters the plurality of search queries corresponding to the information required by the user. In an example, the user enters a search query such as ‘heart attack’ on a personal computer to obtain information related to heart attack required by the user. Furthermore, the client device comprises a memory, a display interface, a processor and so forth.

Moreover, the display interface is a structured set of user-interface elements rendered on a display screen of the client device. The display interface is optionally generated by any collection or set of instructions executable by an associated computing device. Additionally, the display interface is operable to interact with the user to convey graphical and/or textual information and receive input/search query from the user. Specifically, the display interface used herein is a graphical user-interface (GUI). Furthermore, elements of the display interface refer to visual objects that have a size and position within the display interface. A display interface element may be visible, though there may be times when the display interface element is hidden or overlaid on other display interface elements. Examples of display interface elements may include, but are not limited to, text blocks, input area, labels, text boxes, list boxes, lines, images windows, dialog boxes, frames, panels, menus, buttons, icons. In addition to size and position, display interface element may have other properties, such as a margin, spacing, and the like. In an embodiment, the client device comprises display interface for rendering at least first user-interface and second user-interface.

Optionally, the display interface includes at least one graphical element (namely, a display screen), wherein the graphical element is visually associated with the plurality of display elements and a plurality of hierarchical-relations of the hierarchical structure, and wherein the graphical element includes inputs from the user. Furthermore, the at least one graphical element allows for rendering the display interface.

Optionally, the display interface is operable to display one or more additional graphical structures comprising information inferred from the hierarchical structure. Such additional graphical structures includes pie chart, histogram, vertical bar graphs, stacked bar graphs, Horizontal bar, line charts, Area charts, Scatter Plot, Bubble Chart, Funnel Chart, Box Plot and the like.

Moreover, the present description also relates to the method as described above. The various embodiments and variants disclosed above apply mutatis mutandis to the method.

Optionally, the data processing arrangement is further configured to determine an importance score of the plurality of search queries based on a set of predefined parameters.

Optionally, the plurality of display elements corresponding to the plurality of search queries are represented in multiple sizes in the hierarchical structure, and wherein a size of a given display element is determined based on the importance score of the search query corresponding to the given display element.

Optionally, the set of predefined parameters for a given search query from the plurality of search queries comprises at least one of:
number of Uniform Resource Identifiers corresponding to the given search query;
number of Uniform Resource Identifiers corresponding to the given search query accessed by the user; and
metadata associated with each of the Uniform Resource Identifiers corresponding to the given search query.

Optionally, the metadata associated with a given Uniform Resource Identifier comprises at least one of:
access time associated with the given Uniform Resource Identifiers;
type of the given Uniform Resource Identifiers; and
user activity associated with the given Uniform Resource Identifiers.

Optionally, the user activity associated with a given Uniform Resource Identifier comprises at least one of:
recording of web-addresses with the given Uniform Resource Identifiers; and
number of accesses associated with the given Uniform Resource Identifiers.

Optionally, each of the plurality of display elements corresponding to the plurality of search queries comprise an associated summary therewith.

### DETAILED DESCRIPTION OF THE DRAWINGS

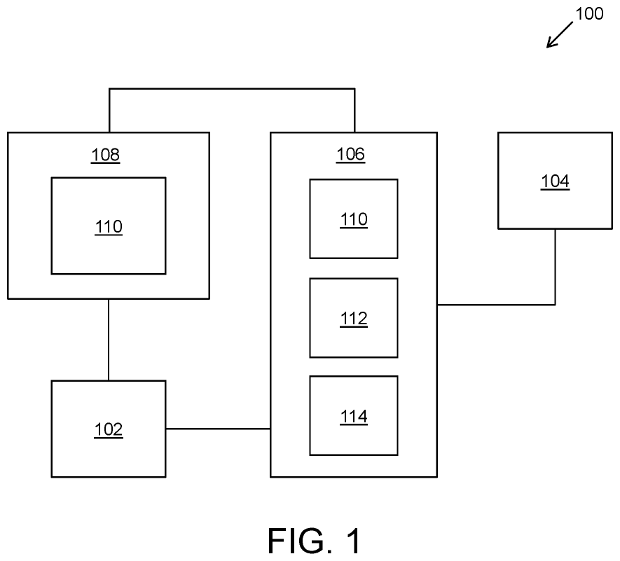

Referring to FIG. 1, illustrated is architecture of a system 100 for visually representing a user's browsing history in a structured manner, in accordance with an embodiment of the present disclosure. The system 100 comprises a memory unit 102, an ontological databank 104 comprising a plurality of concepts, data processing arrangement 106, a client device 108 having a display interface 110. The data processing arrangement 106 comprises a retrieval module 110, an analyzer module 112 and a generator module 114. The memory unit 102 stores the user's browsing history having a plurality of search queries and Uniform Resource Identifiers corresponding to the plurality of search queries. The data processing arrangement 106 is communicably coupled to the memory unit 102 and the ontological databank 104. The retrieval module 110 retrieves the plurality of search queries. The analyzer module 112 analyzes each of the plurality of search queries for determining at least one concept associated with each of the search query, and semantic relations between the plurality of search queries. The generator module 114 generates a hierarchical structure having a plurality of display elements and a plurality of hierarchical-relations between the plurality of display elements. The client device 108 has the display interface 110 for displaying the hierarchical structure.

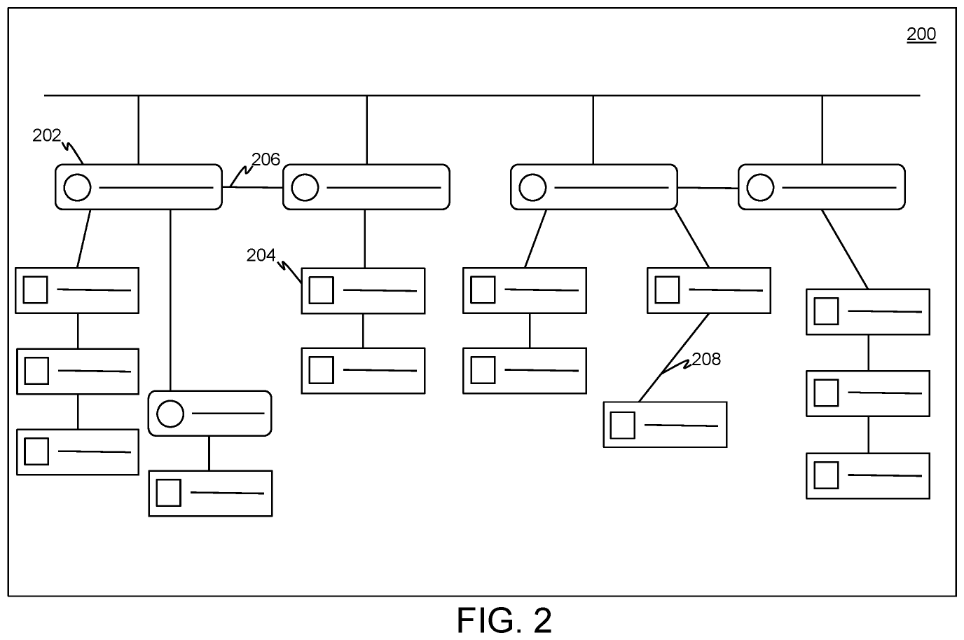

Referring to FIG. 2 illustrated is an exemplary view 200 of a display interface for displaying a hierarchical structure to be displayed on client device, in accordance with an embodiment of the present disclosure. The exemplary view 200 comprises the hierarchical structure having a plurality of display elements and a plurality of hierarchical-relations between the plurality of display elements. The plurality of display elements corresponds to the plurality of search queries depicted as a search query 202 and corresponding Uniform Resource Identifiers depicted as a Uniform Resource Identifier 204. The plurality of hierarchical-relations between the plurality of display elements are generated based on semantic-relations between the plurality of search queries. The plurality of hierarchical-relations depicted as a hierarchical-relation 206 depicts the hierarchical-relation between plurality of search queries. The plurality of hierarchical-relations depicted as a hierarchical-relation 208 depicts the hierarchical-relation between plurality of display elements.

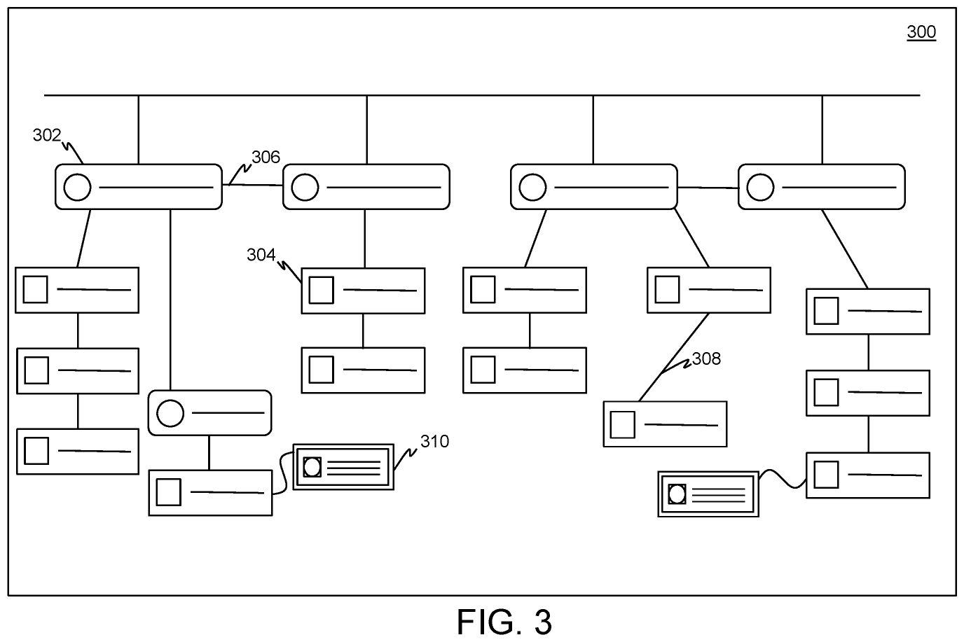

Referring to FIG. 3 illustrated is another exemplary view 300 of a display interface for displaying a hierarchical structure to be displayed on client device, in accordance with another embodiment of the present disclosure. The exemplary view 300 comprises the hierarchical structure having a plurality of display elements and a plurality of hierarchical-relations between the plurality of display elements. The plurality of display elements corresponds to the plurality of search queries depicted as a search query 302 and corresponding Uniform Resource Identifiers depicted as a Uniform Resource Identifier 304. The plurality of hierarchical-relations between the plurality of display elements are generated based on semantic-relations between the plurality of search queries. The plurality of hierarchical-relations depicted as a hierarchical-relation 306 depicts the hierarchical-relation between plurality of search queries. The plurality of hierarchical-relations depicted as a hierarchical-relation 308 depicts the hierarchical-relation between plurality of display elements. Further, the exemplary view 300 comprising plurality of display elements comprise associated summary 310. The summary 310 associated with the plurality of display elements corresponding to the plurality of search queries includes: number of corresponding search results, time of search, date of search, time spent on analyzing results, bookmarks saved using a given search query, keywords of the given search query, number of times the given search query has been used, databases and/or webpages analyzed by a search engine for generating the search corresponding search results and so forth.

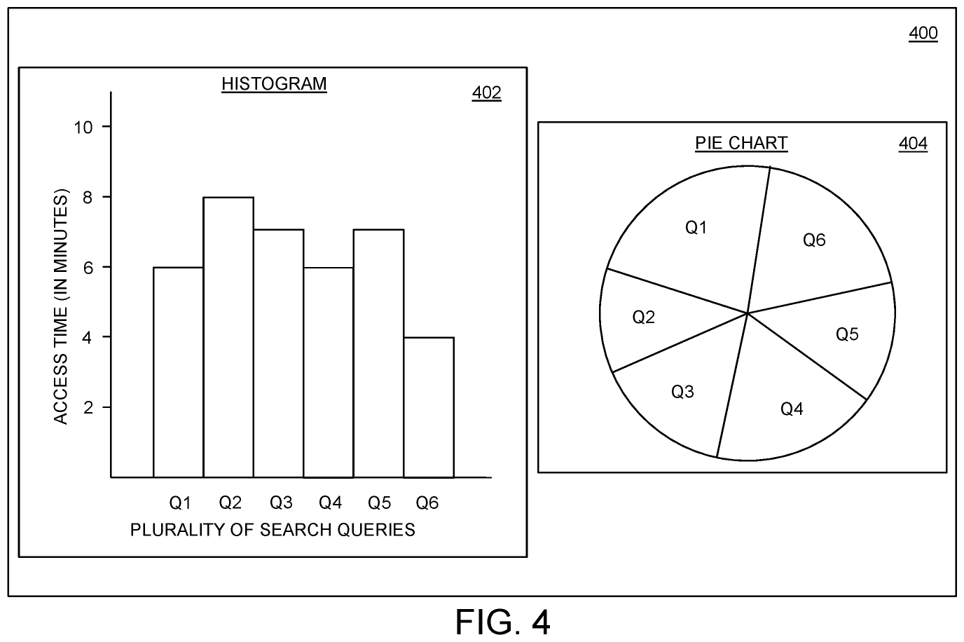

Referring to FIG. 4 illustrated is an exemplary view 400 of a display interface for displaying graphical structures to be displayed on client device, in accordance with an embodiment of the present disclosure. The graphical structures comprise histogram 402 and pie chart 404. The histogram 402 and the pie chart 404 comprise plurality of search queries Q1, Q2, Q3, Q4, Q5 and Q6. The plurality of search queries Q1-Q6 corresponds to Uniform Resource Identifiers (not shown). The histogram 402 represents the access time associated with the Uniform Resource Identifiers corresponding to plurality of search queries. Furthermore, the X-axis in the histogram 402 correspond to plurality of search queries and the Y-axis in the histogram 402 correspond to the access time (in minutes) associated with the Uniform Resource Identifiers. Moreover, the access time associated with the Uniform Resource Identifiers of search query Q1 is 6 minutes; the access time associated with the Uniform Resource Identifiers of search query Q2 is 8 minutes; the access time associated with the Uniform Resource Identifiers of search query Q3 is 7 minutes; the access time associated with the Uniform Resource Identifiers of search query Q4 is 6 minutes; the access time associated with the Uniform Resource Identifiers of search query Q5 is 7 minutes; the access time associated with the Uniform Resource Identifiers of search query Q6 is 4 minutes. The pie chart 402 represents the access time associated with each of the Uniform Resource Identifiers corresponding to each of the plurality of search queries with respect to a total access time associated with all the Uniform Resource Identifiers corresponding to the plurality of search queries.

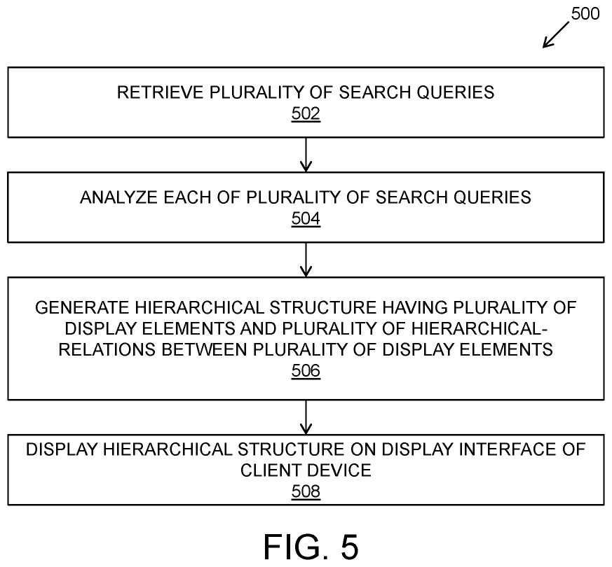

Referring to FIG. 5 illustrated are steps of a method for visually representing a user's browsing history in a structured manner, in accordance with an embodiment of the present disclosure. At step 502, plurality of search queries is retrieved. At step 504, each of the plurality of search queries are analyzed. Furthermore, each of the plurality of search queries are analyzed for determining, at least one concept associated with each of the search query based on at least one keyword present therein using the ontological databank. Moreover, each of the plurality of search queries are analyzed for determining, semantic relations between the plurality of search queries, based on the concepts associated therewith. At step 506, a hierarchical structure having a plurality of display elements is generated. Furthermore, the plurality of display elements corresponds to the plurality of search queries and corresponding Uniform Resource Identifiers. Moreover, the plurality of hierarchical-relations between the plurality of display elements are generated based on semantic-relations between the plurality of search queries. At step 508, the hierarchical structure is displayed on a display interface of a client device. Furthermore, the client device is communicably coupled to the data processing arrangement.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

What is claimed is:

1. A system for visually representing a user's browsing history in a structured manner, the system comprising:
a memory unit for storing the user's browsing history having a plurality of search queries and Uniform Resource Identifiers corresponding to the plurality of search queries;
an ontological databank comprising a plurality of concepts;
a data processing arrangement communicably coupled to the memory unit and the ontological databank, the data processing arrangement comprising:
a retrieval module for retrieving the plurality of search queries,
an analyzer module for analyzing each of the plurality of search queries for determining
at least one concept associated with each of the search query based on at least one keyword present therein using the ontological databank,
semantic relations between the plurality of search queries, based on the concepts associated therewith, and
a generator module for generating a hierarchical structure having a plurality of display elements and a plurality of hierarchical-relations between the plurality of display elements, wherein the plurality of display elements correspond to the plurality of search queries and corresponding Uniform Resource Identifiers, and wherein the plurality of hierarchical-relations between the plurality of display elements are generated based on semantic-relations between the plurality of search queries; and
a client device having a display interface for displaying the hierarchical structure.

2. The system of claim 1, wherein the data processing arrangement is further configured to determine an importance score of the plurality of search queries based on a set of predefined parameters.

3. The system of claim 2, wherein the plurality of display elements corresponding to the plurality of search queries are represented in multiple sizes in the hierarchical structure, and wherein a size of a given display element is determined based on the importance score of the search query corresponding to the given display element.

4. The system of claim 2, wherein the set of predefined parameters for a given search query from the plurality of search queries comprises at least one of:
number of Uniform Resource Identifiers corresponding to the given search query;
number of Uniform Resource Identifiers corresponding to the given search query accessed by the user; and
metadata associated with each of the Uniform Resource Identifiers corresponding to the given search query.

5. The system of claim 4, wherein the metadata associated with a given Uniform Resource Identifier comprises at least one of:
access time associated with the given Uniform Resource Identifiers;
type of the given Uniform Resource Identifiers; and
user activity associated with the given Uniform Resource Identifiers.

6. The system of claim 5, wherein in that the user activity associated with a given Uniform Resource Identifier comprises at least one of:
recording of web-addresses with the given Uniform Resource Identifiers; and
number of accesses associated with the given Uniform Resource Identifiers.

7. The system of claim 1, wherein each of the plurality of display elements corresponding to the plurality of search queries comprise an associated summary therewith.

8. The system of claim 7, wherein the summaries associated with the plurality of display elements is represented using an annotation.

9. A method for visually representing a user's browsing history in a structured manner, wherein the method is implemented using a system comprising:
a memory unit for storing the user's browsing history having a plurality of search queries and Uniform Resource Identifiers corresponding to the plurality of search queries;
an ontological databank comprising a plurality of concepts;
a data processing arrangement communicably coupled to the memory unit and the ontological databank, wherein the method comprises:
retrieving the plurality of search queries,
analyzing each of the plurality of search queries for determining
at least one concept associated with each of the search query based on at least one keyword present therein using the ontological databank,
semantic relations between the plurality of search queries, based on the concepts associated therewith, and
generating a hierarchical structure having a plurality of display elements and a plurality of hierarchical-relations between the plurality of display elements, wherein the plurality of display elements corresponds to the plurality of search queries and corresponding Uniform Resource Identifiers, and wherein the plurality of hierarchical-relations between the plurality of display elements are generated based on semantic-relations between the plurality of search queries, and
displaying the hierarchical structure on a display interface of a client device, wherein the client device is communicably coupled to the data processing arrangement.

10. The method of claim 9, wherein the data processing arrangement is further configured to determine an importance score of the plurality of search queries based on a set of predefined parameters.

11. The method of claim 10, wherein the plurality of display elements corresponding to the plurality of search queries are represented in multiple sizes in the hierarchical structure, and wherein a size of a given display element is determined based on the importance score of the search query corresponding to the given display element.

12. The method of claim 10, wherein the set of predefined parameters for a given search query from the plurality of search queries comprises at least one of:
number of Uniform Resource Identifiers corresponding to the given search query;
number of Uniform Resource Identifiers corresponding to the given search query accessed by the user; and
metadata associated with each of the Uniform Resource Identifiers corresponding to the given search query.

13. The method of claim 12, wherein the metadata associated with a given Uniform Resource Identifier comprises at least one of:
access time associated with the given Uniform Resource Identifiers;
type of the given Uniform Resource Identifiers; and
user activity associated with the given Uniform Resource Identifiers.

14. The method of claim 13, wherein in that the user activity associated with a given Uniform Resource Identifier comprises at least one of:
recording of web-addresses with the given Uniform Resource Identifiers; and
number of accesses associated with the given Uniform Resource Identifiers.

15. The method of claim 9, wherein each of the plurality of display elements corresponding to the plurality of search queries comprise an associated summary therewith.
